(19) United States
(12) Patent Application Publication
(10) Pub. No.: US 2006/0077807 A1
(43) Pub. Date: Apr. 13, 2006

(54) Apparatus having an optical head for reading and/or writing data stored in an optical carrier and method involved in this apparatus

(75) Inventor: Petrus Theodorus Jutte, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/538,612

(22) PCT Filed: Dec. 1, 2003
(86) PCT No.: PCT/IB03/05668

§ 371 Date: Jun. 10, 2005

(30) Foreign Application Priority Data
Dec. 16, 2002 (EP) 02293109.1

(51) Int. Cl. G11B 7/00

(52) U.S. Cl. 369/44.37; 369/112.01

(57) ABSTRACT

This apparatus comprises an optical head (10) for reading and/or writing data stored in an optical carrier (1) having a circular shape, comprising tracks (100) wound round a center. This apparatus comprises, in particular: an optical assembly constituting said head, having a main light path direction (XX′) defined by the direction of the light emitted by a first laser device and/or by reflecting mirror devices, and an exit pupil (63), including a beam shaper (52), a moving part (16) for moving said optical head in a moving direction which is perpendicular to the tracks (100), the light path direction and the moving direction enclosing an angle for achieving an adequate light intensity at the level of said exit pupil. This apparatus is well suited for reading and/or writing CDRW and DVD.

The present invention relates to an apparatus comprising an optical head for reading and/or writing data in an optical carrier having a circular shape, comprising tracks wound round the center of the carrier, this apparatus comprising:
an optical assembly constituting said head for providing a light spot onto the carrier, having a main light path direction defined by the direction of the light emitted by a first laser device and/or by reflecting mirror devices, and an exit pupil,
a moving part for moving said optical head in a moving direction which is perpendicular to the tracks, the light path direction and the moving direction enclosing an angle for achieving an adequate light intensity at the level of said exit pupil.

This apparatus finds many applications, notably for data carriers constituted by optical discs. For obtaining a good processing of the data, a usual requirement is that the light spot created from the laser must be perfectly defined.

The patent document WO 02/089126 discloses such an apparatus. Although this apparatus provides satisfaction, it has been deemed desirable to improve it so that the requirement of the defined spot is satisfied without using extra materials.

The invention proposes an above-mentioned apparatus in which measures are provided to obtain a right spot easily. Moreover, the apparatus has the advantage that the optical head retains a compact shape without wasting unnecessary space.

For this purpose, said apparatus comprises an optical head for reading and/or writing data in an optical carrier having a circular shape, comprising tracks wound round the center of the carrier, and said apparatus comprises:
an optical assembly constituting said head for providing a light spot onto the carrier, having a main light path direction defined by the direction of the light emitted by a first laser device and/or by reflecting mirror devices, and an exit pupil, and
a moving part for moving said optical head in a moving direction which is perpendicular to the tracks, the light path direction and the moving direction enclosing an angle for achieving an adequate light intensity at the level of exit pupil.

The invention also proposes a method of reading and/or writing an optical data carrier, comprising the step of:
providing an angle between a main light path direction of an optical head and tracks which are fitted in the data carrier, so as to satisfy requirements for reading and/or writing this optical data carrier.

It must be considered that this angle has hardly any effect on the reading or writing spot when a beam shaper is applied, because it renders the asymmetrical beam of the semiconductor laser more or less circularly symmetrical.

These and other aspects of the invention are apparent from and will be elucidated, by way of non-limitative example, with reference to the embodiment(s) described hereinafter.

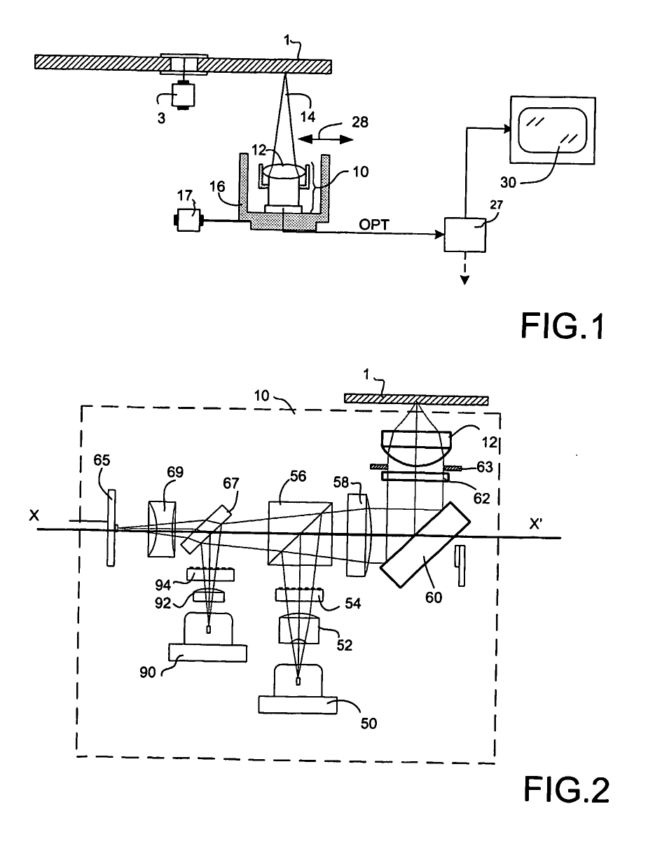

FIG. 1 shows an apparatus in accordance with the invention.

FIG. 2 shows an optical head comprised in said apparatus according to the invention.

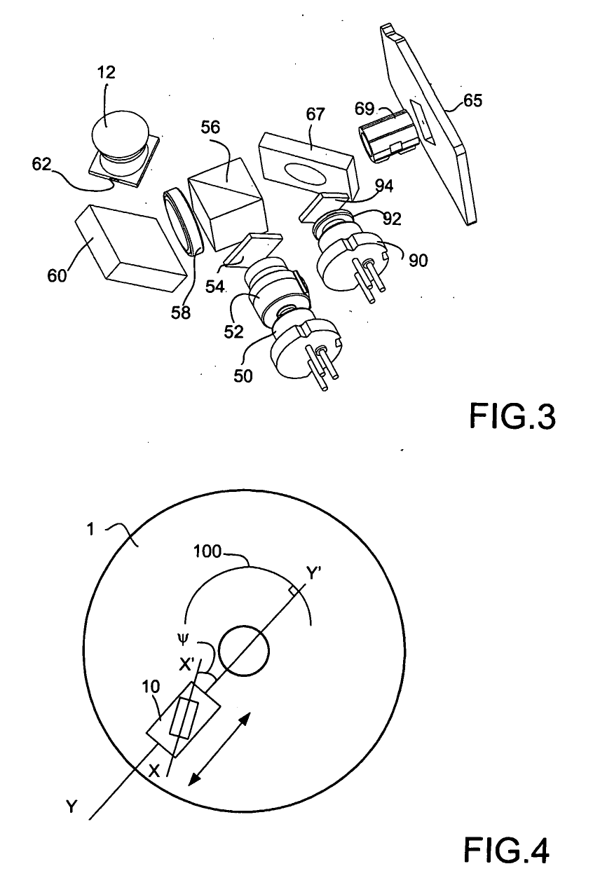

FIG. 3 shows a first embodiment of an optical head according to the invention.

FIG. 4 shows the proposed angle according to an aspect of the invention.

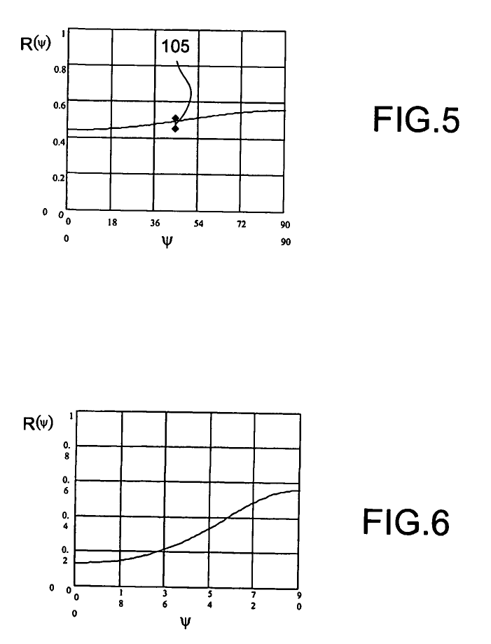

FIG. 5 is a diagram showing the light intensity for a DVD as a function of the angle.

FIG. 6 is a diagram showing the light intensity for a CD as a function of the angle.

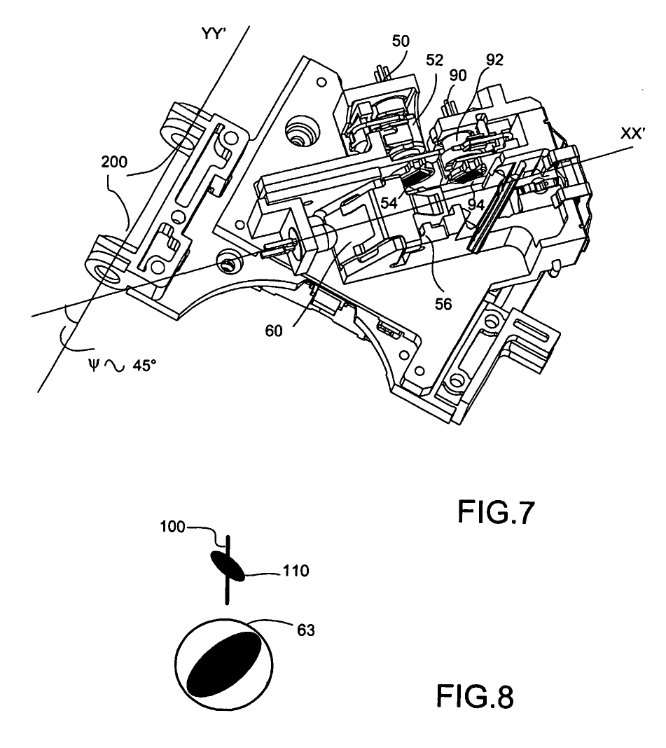

FIG. 7 shows a construction on which the optical head is mounted.

FIG. 8 shows light intensity at the exit pupil level with regard to the spot on the track.

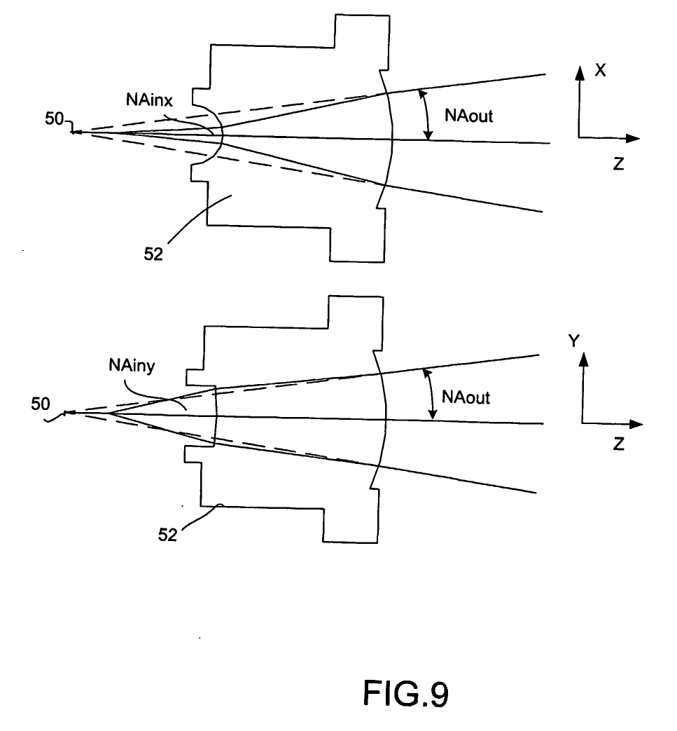

FIG. 9 shows the definition of a beam shaper suitable for invention.

FIG. 1 shows an apparatus in which a data carrier 1, notably an optical disc, is placed. The data carrier is shown in cross section. An optical head 10 comprising a lens 12 focuses a laser light beam 14 on this carrier, which is driven into a circular movement by a motor 3. This optical head 10 is placed in a moving part using a sledge 16 for large displacements and using actuators (non shown in the Figures.) for small displacements. The sledge 16 is moved by means of a motor 17. These displacements are performed in directions indicated by arrows 28. The signal OPT at the output of the unit 16 is applied to a signal distributor 27, which provides signals for a display unit 30 so that the content of the disc can be displayed with some other information useful to a user of the apparatus. The distributor also provides other signals for the operation of the apparatus.

FIG. 2 shows the optical head 10 in accordance with the invention. The head comprises a first diode laser 50. The light beam provided by this laser 50 is made circular by a beam shaper 52 which may be of a dichroïcally polarizing type. The beam goes through the three-spot grating 54 towards a dichroic beam splitter 56. Advantageously, this beam splitter has a cubic shape. At the output of the splitter 56, the beam is made parallel by a collimator lens 58 and is reflected by a folding mirror 60, whereupon its polarization state is rotated 90° and changed into a circular polarization by the λ/4 plate 62. The rim 63 delimits the exit pupil. Finally, the beam is focused by the objective lens 12. It must be noted that the elements 60, 62 and 12 have to be considered as rotated 90° into the plane perpendicular to the Figure.

After reflection on the disc 1, the polarization of the beam is rotated 90° with regards to the original state by the plate 62. Then the beam is directed to a detector 65 via the mirror 60, the lens 58, the cube 56, another dichroic beam splitter 67, and a servo lens 69, which is used for focusing the spot on disc in conjunction with an electromechanical servosystem during operation of the apparatus. The servo lens has a cylindrical surface for generating an extra astigmatism for the astigmatic focusing method and a negative spherical lens for focus adjustment. This lens may provide some correction of the coma generated by the parallel plate 67. It is possible to define an optical axis of this head, for instance the light passing to the detector 65. It is referenced XX′ in this Figure. This axis is perpendicular to the light path emitted by the lasers 50 and 90.

Advantageously, the beam splitter 56 has a cubic shape. Thanks to this shape, no undesired aberrations are generated in the transmitted CD beam and the polarizsation is better than that provided by the other splitters.

In a preferred embodiment, the invention proposes to combine another laser 90 in the same optical head 10. The light from this laser 90 passes through a pre-collimator lens 92 for coupling enough power into the disc 1 and through a grating 94 for forming the three spots in the same manner as disclosed for the laser 50 and is directed to the cubic-splitter 56 via the splitter 67. The path of the light is the same that for the other laser 50 up to the detector 65.

The spot and light path orientation are coupled because of the polarizing properties of the laser and the beam splitters if no extra polarization rational component are applied such as a λ/4 plate. Such components increase the cost of the optical pick-up.

FIG. 3 is an exploded view of the head 10 in which the optical elements already mentioned are present. This is for a better understanding of the invention.

According to a feature of the invention, the axis XX′ encloses an angle with the moving direction YY′ of the head, as is shown in FIG. 4. The YY′ direction is perpendicular to the track, as is shown for a given track 100. This axis may be met with the direction defined by the arrow 28. The determination of the angle ψ enclosed by XX′ and YY′ is made by considering the following.

In FIG. 5 and FIG. 6, the rim light intensity R(ψ) at the exit pupil 63 depends of the angle ψ. The curves shown are given for a Gaussian laser beam. In FIG. 5, which relates to the laser 50 suited for processing of DVD discs, the variation of the intensity is very small, when the beam shaper 52 is used. As the specifications concerning the DVD+RW require a rim intensity of 45-50° see the arrow 105 in this Figure, the order of magnitude of the angle ψ is 45° too. So, the typical exit pupil and the spot formed onto the disc have to be in accordance with the DVD+RW spot in the disc standard when the spot orientation is 45° with regard to the track on the disc. In FIG. 6 relating to the rim light intensity of the laser 90 suited for the processing of CDR(W), the variation of this intensity is rather strong.

FIG. 7 shows, in a perspective view, the construction on which the head 10 is mounted. The reference 200 indicates bearings for a shaft. These bearings are arranged in the direction YY′, some elements of the head shown in this Figure are not visible because they are placed behind the construction. The axis XX′ is given by the path of the light going to the detector 65.

FIG. 8 shows the light intensity at the rim of the exit pupil 63 and the shape of the spot 110 at the level of the track 100 on the disc 1. It is to be noted that the spot is of the DOS type (diagonal oval spot) which is required for reading/writing the CDR(W).

It should be added that a round spot is required for writing DVD recordable discs, and that therefore a beam shaper is preferred. Consequently, the spot orientation with respect to the tracks on disc is free.

The values are for this example:

| | Numerical | | |
|---|---|---|---|
| | Aperture of | | Beam shaper |
| Type of disc | collimator | Laser Beam | magnification |
| DVD | 0.14 | 9 × 22° | 0.8×/1.64× |
| CD | 0.135 | 9 × 17° | 1×/1× |

The DVD+RW standard requires a shaped beam and therefore an almost round spot (FIG. 5). In detail, the light intensity at the rim of the pupil is given by 35 to 50% of the maximum intensity in the radial direction and 45 to 60% in the tangential direction in the DVD+RW standard. These limits can also be fulfilled with a beam shaped as a DOS, see the black dots in FIG. 5. The spot and light path orientation are coupled because of the polarizing properties of the laser and the dichroic or polarizing beam splitter. The recording properties are very sensitive to the spot shape and orientation.

For CDR(W) the standard is a beam shaped as a DOS with rim intensities defined as a minimum of 57±5% for the highest intensity and 17±5% for the lowest intensity. The shape of the spot is oval with a 45° orientation. This is shown in FIG. 6.

The advantages obtained by the measures of the invention are the following ones:
1—The astigmatism of the plane parallel plate fits both desired directions: focus and push-pull detection. The plate and cylinder lens astigmatism may have the same orientation, or no cylinder lens is needed.
2—The orientation of the spot on disk will be a DOS (Diagonal Oval Spot) for CDR(W). This is the same as described in the CDR(W) orange book high-speed standard. Another orientation is possible if the plate is non-polarizing.
3—More efficient use of the footprint (space) for the optics.
4—Synergy in manufacturing equipment of standard CDR(W) and combining two lasers in one optical head.
5—No extra polarization rating components are needed such as a λ/4 plate. Such components will increase the cost of the optical pick-up.

FIG. 9 shows the definition of a beam shaper 52 suitable for the invention. The beam shaper magnification in x and y are respectively Mₓ and M_{y}:

$${M}_{x} = \frac{{NA}_{out}}{{NA}_{inx}} and {M}_{y} = \frac{{NA}_{out}}{{NA}_{iny}}$$

NAₒᵤₜ, NAᵢₙₓ and NA_{iny} are the numerical apertance of output beam and input beam. This FIG. 9 shows cross sections of the beam shaper. The z-axis is the optical axis. In this drawing the x-axis is parallel with the X-X′ axis. The y-axis is perpendicular to the x- and z-axis. The X and Y axis are projected at 45° with respect to the tracks on disk by means of the beam splitter cube 56 and mirror 60 (see FIG. 3).

1- An apparatus comprising an optical head for reading and/or writing data in an optical carrier having a circular shape, comprising tracks wound round the center of the carrier, this apparatus comprising:
an optical assembly constituting said head for providing a light spot onto the carrier, having a main light path direction defined by the direction of the light emitted by a first laser device and/or by reflecting mirror devices, and an exit pupil,
a moving part for moving said optical head in a moving direction which is perpendicular to the tracks, the light path direction and the moving direction enclosing an angle for achieving adequate light intensity at the level of said exit pupil.

2- An apparatus as claimed in claim 1, wherein the order of magnitude of said angle is 45°.

3- An apparatus as claimed in claim 2, the magnitude of said angle is 45°±1.

4- An apparatus as claimed in claim 1, wherein said angle is given by a correct illumination of said exit pupil, considering that a diagonal oval spot is required for a processing of data on said carrier.

5- An apparatus as claimed in claim 1, suitable for optical carriers of the DVD recordable type, wherein the spot is a diagonal spot having a 45° orientation with regard to the track direction.

6- An apparatus as claimed in any of the claim 1, wherein a beam shaper is provided in the light path of the laser.

7- An apparatus as claimed in any of the claim 1, wherein a second laser device is provided.

8- A method of reading and/or writing an optical data carrier, comprising the step of:
providing an angle between a main light path direction of an optical head and tracks which are fitted in the data carrier, so as to satisfy requirements for reading and/or writing this optical data carrier.

9- An optical head suited for an apparatus as claimed in claim 1.
